(19) United States
(12) Patent Application Publication
(10) Pub. No.: US 2025/0116598 A1
(43) Pub. Date: Apr. 10, 2025

(54) ENHANCED MODES FOR SCANNING ACOUSTIC MICROSCOPE INSPECTION IN SEMICONDUCTOR INSPECTION

(71) Applicant: KLA Corporation, Milpitas, CA (US)

(72) Inventors: Daniel Ivanov Kavaldjiev, San Jose, CA (US); Juergen REICH, Milpitas, CA (US); David Owen, Milpitas, CA (US)

(21) Appl. No.: 18/756,416

(22) Filed: Jun. 27, 2024

Related U.S. Application Data
(60) Provisional application No. 63/542,545, filed on Oct. 5, 2023.

(51) Int. Cl. G01N 21/17; G01N 21/88; G01N 21/95; G01N 21/956

(52) U.S. Cl. CPC G01N 21/1702; G01N 21/8851; G01N 21/9501; G01N 21/956

(57) ABSTRACT

A scanning acoustic microscope system may include one or more measurement assemblies, wherein a respective one of the measurement assemblies comprises a transducer and a receiver, wherein the receiver of at least one of the one or more measurement assemblies comprises a multipixel sensor to simultaneously generate sensor data for multiple locations associated with a sample. The tool may include a stage configured to scan the sample for measurement by the one or more measurement assemblies. The tool may include a controller communicatively coupled to the one or more measurement assemblies, wherein the controller includes one or more processors configured to execute program instructions causing the processors to implement a metrology recipe by: receiving the sensor data from the one or more measurement assemblies while the sample is scanned by the stage; and generating one or more measurements for the sample based on the sensor data.

### CROSS-REFERENCE TO RELATED APPLICATION

The present application claims the benefit under 35 U.S.C. § 119 (e) of U.S. Provisional Application Ser. No. 63/542,545, filed Oct. 5, 2023, which is incorporated herein by reference in the entirety.

### TECHNICAL FIELD

The present disclosure relates to wafer inspection and, more particularly, to wafer inspection by scanning acoustic microscopy

### BACKGROUND

Scanning optical microscopy (SAM) can be used as a non-destructive approach for inspection of wafers and other surfaces during semiconductor fabrication and is particularly useful for detecting image defects in multilayer structures. Current limitations of SAM is its use in high-throughput manufacturing and resulting tradeoffs. For example, faster inspection speeds by SAM devices often result in lower resolution and sensitivity of the scanned surfaces.

There is therefore a need to develop systems and methods that increase scanning speed without reducing scanning resolution or sensitivity.

### SUMMARY

A scanning acoustic microscope system is disclosed, in accordance with one or more embodiments of the disclosure. In one embodiment, the scanning acoustic microscope system includes one or more measurement assemblies, wherein a respective one of the measurement assemblies includes a transducer and a receiver, wherein the receiver of at least one of the one or more measurement assemblies may include a multipixel sensor to simultaneously generate sensor data for multiple locations associated with a sample; a stage configured to scan the sample for measurement by the one or more measurement assemblies; and a controller communicatively coupled to the one or more measurement assemblies, wherein the controller includes one or more processors configured to execute program instructions causing the one or more processors to implement a metrology recipe by receiving the sensor data from the one or more measurement assemblies while the sample is scanned by the stage; and generating one or more measurements for the sample based on the sensor data.

In some aspects, the techniques described herein relate to a scanning acoustic microscope system, including: a controller communicatively coupled to one or more measurement assemblies and a stage, wherein a respective one of the measurement assemblies includes a transducer and a receiver, wherein the receiver of at least one of the one or more measurement assemblies includes a multipixel sensor to simultaneously generate sensor data for multiple locations associated with a sample, wherein the stage is configured to scan the sample for measurement by the one or more measurement assemblies, wherein the controller includes one or more processors configured to execute program instructions causing the one or more processors to implement an inspection recipe or a metrology recipe by: receiving the sensor data from the one or more measurement assemblies while the sample is scanned by the stage; and generating one or more measurements for the sample based on the sensor data.

In some aspects, the techniques described herein relate to a method, including receiving sensor data from one or more measurement assemblies while a sample is scanned by a stage, wherein a respective one of the measurement assemblies includes a transducer and a receiver, wherein the receiver of at least one of the one or more measurement assemblies includes a multipixel sensor to simultaneously generate sensor data for multiple locations associated with the sample; and generating one or more measurements for the sample based on the sensor data.

### BRIEF DESCRIPTION OF THE DRAWINGS

The numerous advantages of the disclosure may be better understood by those skilled in the art by reference to the accompanying figures.

FIG. 1 illustrates a block diagram of a scanning acoustic microscope system for inspecting substrates, in accordance with one or more embodiments of the present disclosure.

FIG. 2A-2C illustrate a scanning of a sample by different sensors, in accordance with one or more embodiments of the disclosure.

FIG. 3A-3B illustrate examples of interleaved measurement assembly configurations for scanning a sample, in accordance with one or more embodiments of the disclosure.

FIG. 4 is a conceptual view illustrating a scanning acoustic microscope system 100 that includes a rotational stage rotated by a spindle, in accordance with one or more embodiments of the disclosure.

FIG. 5A illustrates test scans of a sample scanned under different acoustic frequencies, in accordance with one or more embodiments of the disclosure.

FIG. 5B illustrates test scans of a sample scanned under different transducer powers, in accordance with one or more embodiments of the disclosure.

FIG. 6. Illustrates a process flow diagram depicting a method for measuring a sample via the scanning acoustic microscope system, in accordance with one or more embodiments of the disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods for increasing the inspection speed of scanning acoustic microscopy (SAM) of samples such as wafers without reducing scan resolution or sensitivity. The system includes a measurement assembly that includes a transducer and a receiver. The receiver may include a multipixel sensor that can generate sensor data for multiple locations associated with a sample. The system may utilize one or more SAM sensor configurations, such as arrayed SAM sensor sets that interleave at each pass, one or more SAM sensor scan capabilities (e.g., scanning with different pixel shapes), as well as one or more scanning modes such selectively scanning the outer radial edge region of the sample along a radial axis.

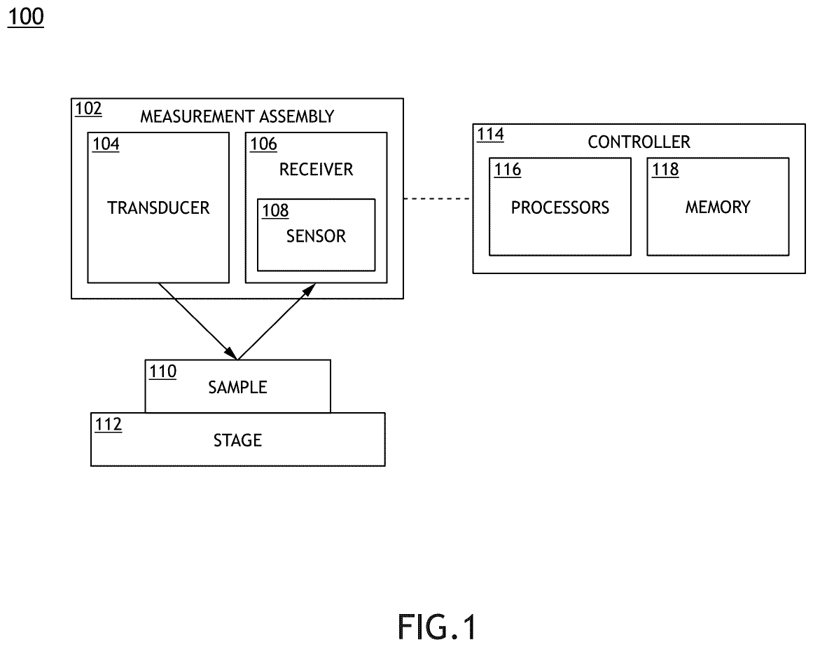

Referring now to FIGS. 1 through 6, systems and methods for inspecting substrates via SAM, in accordance with one or more embodiments of the present disclosure.

FIG. 1 illustrates a block diagram of a scanning acoustic microscope system 100 for inspecting substrates, in accordance with one or more embodiments of the present disclosure.

In embodiments, the scanning acoustic microscope system 100 includes one or more measurement assemblies 102. The one or more measurement assemblies 102 include a transducer 104 for transmitting an acoustic signal and a receiver 106 for receiving a reflected acoustic signal. The receiver 106 may include a sensor 108 (e.g., a multipixel sensor) that simultaneously generates sensor data for multiple locations associated with a sample 110, such as a wafer or other semiconductor substrate. The scanning acoustic microscope system 100 may further include a stage 112, such as a translation stage or a rotating stage or both, configured to adjust, move, and/or scan the sample 110 relative to the measurement assembly 102. For example, the stage 112 may be configured so that the sample 110 is moved by the stage 112 relative to the measurement assembly 102. In another example, the stage may be configured so that the measurement assembly 102 is moved by the stage 112 relative to the sample 110. In another example, the transducer and the sensor are part of the same integrated circuit (e.g., same chip).

In embodiments, the scanning acoustic microscope system 100 includes one or more controllers 114 with one or more processors 116 configured to execute program instructions maintained on a memory 118. For example, the memory 118 may maintain program instructions configured to cause the one or more processors 116 to carry out any of the one or more process steps described throughout the present disclosure. For instance, the program instructions may include implementing a metrology recipe or inspection recipe. In particular, the program instructions may include receiving the sensor data from the one or more measurement assemblies 102 while the sample 110 is scanned. The program instructions may also include generating one or more measurements (e.g., inspection measurements or metrology measurements) for the sample 110 based on the sensor data. In another example, the program instruction may include implementing the metrology recipe or inspection recipe by at least one of identifying or classifying defects on the sample based on the measurements. The controller may be communicatively coupled to the one or more measurement assemblies 102 and the stage 112.

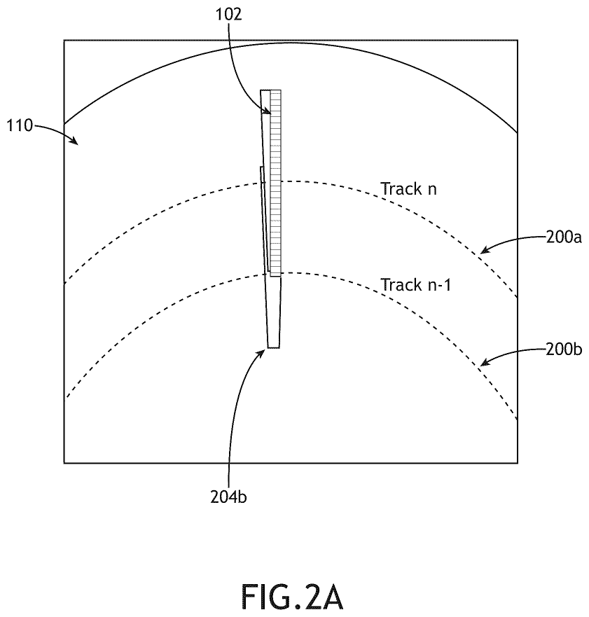

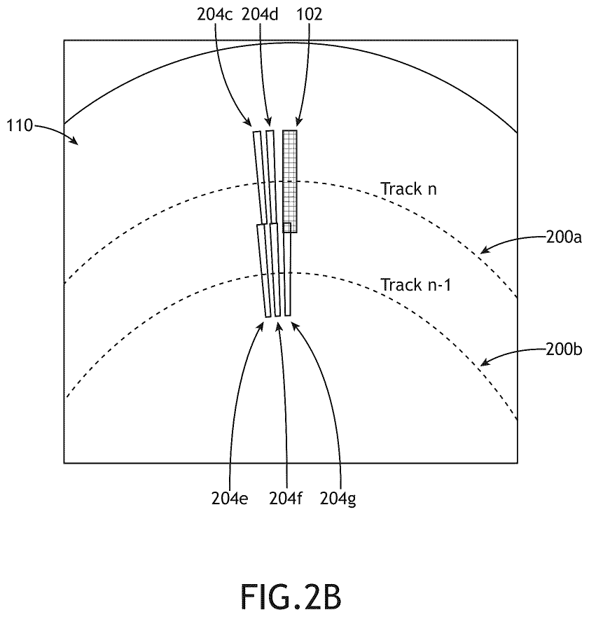

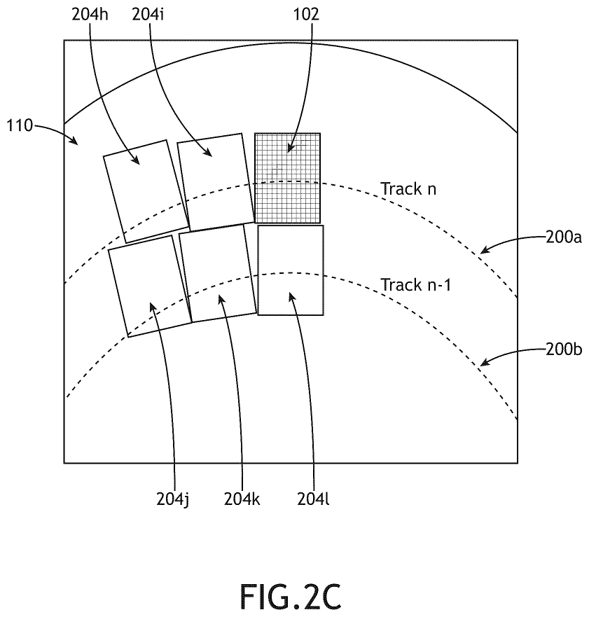

FIG. 2A-C illustrate a scanning of a sample 110 (e.g., a wafer) by different measurement assembly 102, in accordance with one or more embodiments of the disclosure. The scanning acoustic microscope system 100 may operate under different system configurations using a combination of different builds of measurement assembly 102 along with different methods for scanning with the different builds.

FIG. 2A illustrates a sample 110 scanned by a measurement assembly 102 configured as a one-dimensional line multipixel sensor 108, in accordance with one or more embodiments of the disclosure. For example, the measurement assembly 102 may include a line of sensor units that scan and record one line of pixels at a time as the sample 110 is moved (e.g., scanned either in an X-Y direction or a rotational (R-θ) direction). Previously scanned sections 204a-b of the sample 110 are recorded and later pieced together to create a map of the overall scanned area.

FIG. 2B illustrates a sample 110 scanned by a measurement assembly 102 configured as a two-dimensional measurement assembly array scanning in a time-delayed-integration mode (TDI), in accordance with one or more embodiments of the disclosure. For example, the measurement assembly 102 may include a 2D array of measurement assembly subunits that scan an area of pixels at a time as the sample 110 is moved (e.g., scanned either in an X-Y direction or a rotational (R-θ) direction). For instance, the 2D array may scan adjacent areas of the sample 110 sequentially, with a representative image of the sample assembled from the arrangement of scans from previously scanned sections 204c-g.

FIG. 2C illustrates a sample 110 scanned by a measurement assembly 102 configured as a two-dimensional measurement assembly array scanning in a step-and-scan (e.g., flash-on-the-fly) mode, in accordance with one or more embodiments of the disclosure. For example, the measurement assembly 102 may include a 2D array of measurement assembly subunits that scan a section of the sample at a time. Once the section is scanned, the stage 112 and/or measurement assembly 102 moves to another section, of the sample 110 and scanning resumes. A representative image of the sample 110 may then be assembled from the arrangement of scans from previously scanned sections 204h-l.

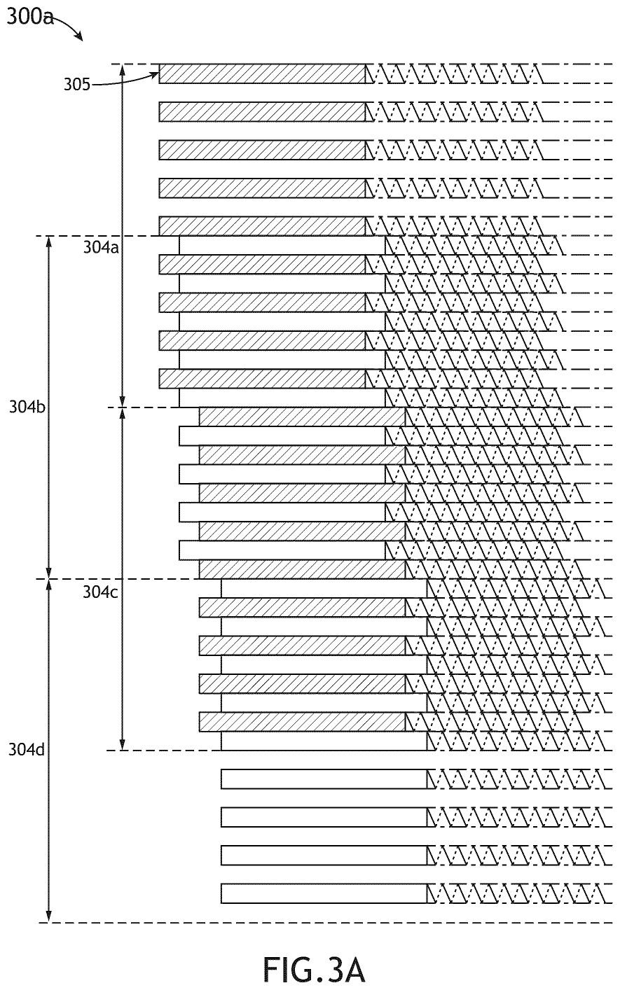

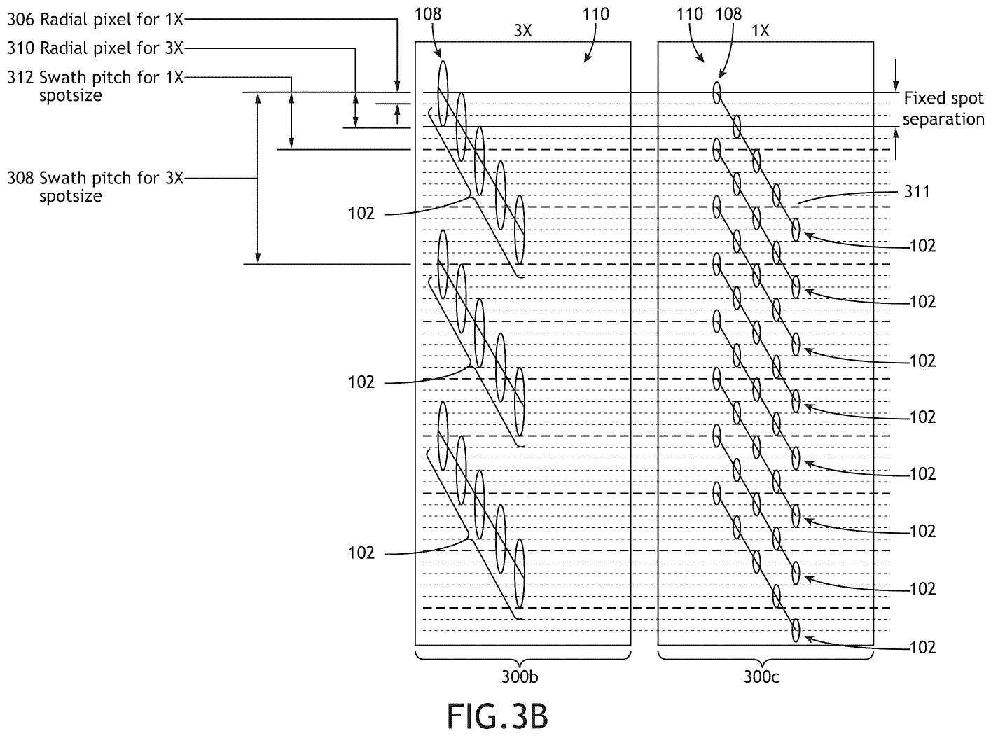

FIG. 3A-3B illustrate examples of measurement assembly configurations 300a-c for scanning a sample 110, in accordance with one or more embodiments of the disclosure. For example, configuration 300a may include a measurement assembly 102 configured as a multipixel sensor 108 containing nine sensor subunits that are distributed along a channel direction and provide pixel sizes (e.g., measurement areas) equal to half the spacing along the channel direction, as shown in FIG. 3A. In this configuration, scanning a swath 304a of the sample 110 along a scan direction orthogonal to the channel direction may generate nine channels 305 of data, each associated with one of the sensor units, where gaps remain between areas of the sample measured by the sensor units. Once the initial measurement swath 304a is finished, the measurement assembly 102 or the translation stage 112 moves or translates to another portion of the sample 110 orthogonal to the scan direction (e.g., along the channel direction) so that the sensor units are arranged in a second swath 304b to measure between at least some of the gaps between areas measured by the sensor units during the first swath 304a. This process may continue until a selected portion of the sample is fully characterized by the measurement assembly 102. For example, FIG. 3A depicts third and fourth measurement swaths 304c-d, which are interleaved similarly to the first two measurement swaths 304a,b. In this manner, the entire surface of the sample 110 can be efficiently scanned, as the translation stage 112 is configured to translate the sample along two or more measurement swaths, with at least one measurement swath at least partially interleaved with a second measurement swath, which at least partially fill at least some of the gaps of the second measurement swath. The interleaved swath may be performed both in an X-Y manner, or in a rotational R-θ manner.

Referring to FIG. 3B, the scanning acoustic microscope system 100 may include a measurement assembly 102 (e.g., configured as a multipixel sensor 108 that includes five sensor units) capable of scanning with different measurement assembly configurations 300b-c. The different measurement assembly configurations 300b-c enable multi-sensor scanning with different resolutions. For example, the measurement assembly 102 may switch between a low-resolution measurement assembly configuration 300b where the sensor units scan with a relatively large pixel size, and a high-resolution measurement configuration 300c where the sensor units scan with a smaller pixel size. For instance, in a low-resolution measurement assembly configuration 300b, the pixel sizes of the sensor units are large enough that there are no gaps along the channel direction. In particular, the measurement condition 300b provides that the sensor units have pixel dimensions of twice the separation distance along the channel direction to ensure complete swath coverage. By scanning without gaps between sensor units, the low-resolution assembly configuration 300b utilizes a swath pitch 308 approximately the same width as the measurement assembly 102 along the channel direction, enabling the measurement assembly 102 to scan the portion of the sample 110 in three successive non-overlapping swaths. In another instance, in a high-resolution measurement assembly configuration 300c, higher-resolution scans are achieved by reducing the area imaged by individual sensor units (e.g., the pixel size). For example, one or more sensor units may include imaging lenses that are adjustable, enabling the pixel size to be reduced by changing the magnification of the imaging lenses. As an illustration, the pixel sizes of the sensor units in the low-resolution measurement assembly configuration 300c are ⅓ the height of the pixel sizes of the sensor units in the high-resolution measurement assembly configuration 300b. This reduction in pixel size also increases the resolution of scanning three-fold. Due to the decreased height scanned by the sensor units in the high-resolution measurement assembly configuration 300c, gaps 311 may occur in the surface coverage between the sensor units. To ensure full surface coverage, the swaths by the measurement assembly 102 are interleaved, with a swath pitch 312 of the high-resolution assembly configuration 300c approximately ⅓ the size of a swath pitch 308 of the low-resolution assembly configuration 300b. Because of the smaller swath pitch, the measurement assembly 102 scanning in the high-resolution measurement assembly configuration 300c may require more swaths (e.g., eight) to cover a particular portion of the sample 100 than when utilizing the low-resolution measurement assembly configuration 300b.

Different measurement assembly configurations 300 may be utilized for scanning the sample 110. For example, and as shown in FIGS. 3A and 3B, the measurement assembly may have a fixed spacing and be configured to switch between scanning of different pixel sizes. In another example, the measurement assembly 102 may have a fixed spacing and be configured to switch between scanning of different pixel shapes. In another example, the measurement assembly 102 may be configured to alter the spacing between one or more sensor units. In another example, the measurement assembly 102 may include different numbers of sensor units. For instance, the measurement assembly configuration 300a included a measurement assembly 102 configured with a multipixel sensor 108 having nine sensor units, while measurement assembly configurations 300b-c include measurement assemblies 102 configured with a multipixel sensor 108 having five sensor units. Therefore, the above description should not be interpreted as a limitation on the embodiments of the present disclosure but merely as an illustration.

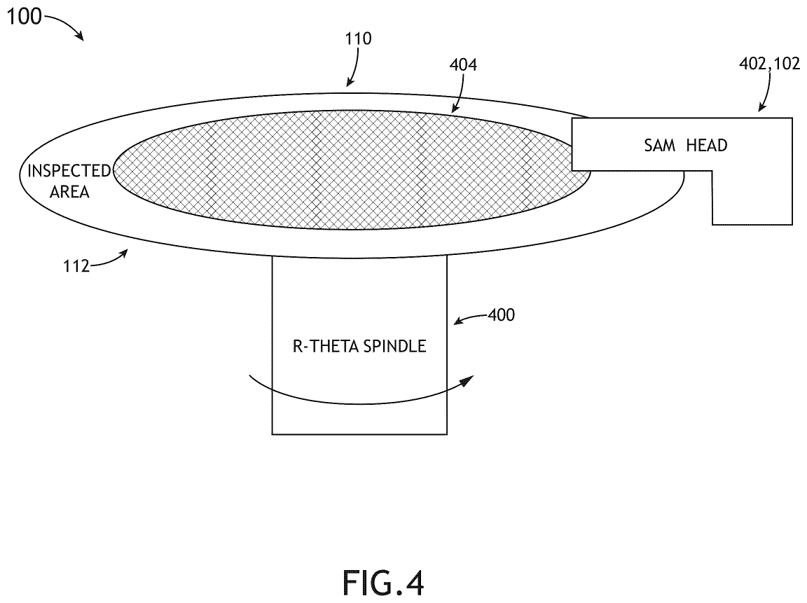

108 FIG. 4 illustrates a simplified schematic of a scanning acoustic microscope system 100 that includes a rotating stage 112 rotated by a spindle 400, in accordance with one or more embodiments of the disclosure. The stage 112 rotates the sample 110 while a scanning head 402 that includes one or more measurement assemblies 102 takes R-θ measurements (e.g., the channel direction is aligned along a radial axis of the sample 110). The stage 112 may also position an outer radial edge of the sample 110 under the one or more measurement assemblies 102 for the measurement.

In embodiments, operation of the scanning acoustic microscope system 100 includes an edge or near edge inspection mode. For example, the edge inspection mode may be used for wafer (e.g., sample 110) inspection methods, such as inspections of wafer-wafer bonding, where voids often occur close to the wafer edge. The edge inspection mode may include positioning one or more measurement assemblies 102 at an outer annulus of the sample 110 so that the channel direction is aligned along a radial axis of the sample 110 and that the stage 112 rotates the sample during the measurement. The edge inspection mode may also include slowing down the inspection speed starting at a specific radius until the edge of the wafer is reached in order to increase signal-to-noise (SNR) for better detection. For instance, different annuli within the sample may correspond to different measurement zones where the measurement zone of the outer annuli spins faster than the measurement zones of the inner annuli. Adjusting the inspection speed compensates for differences in annuli spin.

The edge inspection mode may also use a denser sampling scheme in order to increase the likelihood of locating defects in an edge zone 404 or other measurement zone. The edge inspection mode may utilize other methods for improving sensitivity in wafer inspection by virtue of covering only a limited wafer area.

In embodiments, the scanning acoustic microscope system 100 is designed for inspecting the edge zone 404. For example, the scanning acoustic microscope system 100 may incorporate a rotating stage 112 for inspection of the edge zone 404 (e.g., annulus) of the sample 110. For instance, for a 300 mm wafer, the scanning acoustic microscope system 100 may inspect a region of the outer portion of the wafer (e.g., ranging from 60 mm from the center of the wafer to the edge to 130 mm from the center to the edge).

For instance, for a 300 mm wafer, the scanning acoustic microscope system 100 may be configured to inspect the outer 20 mm of the wafer (e.g., from a radius of 130 mm to 150 mm). In another instance, the scanning acoustic microscope system 100 may be configured to inspect the outer 30 mm of the wafer (e.g., from a radius of 120 mm to 150 mm). In another instance, the scanning acoustic microscope system 100 may be configured to inspect the outer 40 mm of the wafer (e.g., from a radius of 110 mm to 150 mm). In another instance, the scanning acoustic microscope system 100 may be configured to inspect the outer 50 mm of the wafer (e.g., from a radius of 100 mm to 150 mm). In another instance, the scanning acoustic microscope system 100 may be configured to inspect the outer 60 mm of the wafer (e.g., from a radius of 90 mm to 150 mm).

In embodiments, the configuration of the measurement assembly 102 of the scanning acoustic microscope system 100 scanning in R-θ mode includes a linear array configuration (e.g., for increased field of view in the radial direction). For example, the measurement assemblies 102 may be configured in an arrayed and interleaved configuration, as shown in FIGS. 3A-3B.

In embodiments, the scanning acoustic microscope system 100 scanning in R-θ mode is configured to scan pixels of the sample 110 that are non-square (e.g., optimized for R-θ scanning mode). For example, the sensor 108 of the scanning acoustic microscope system 100 may be configured to scan pixels with unequal pixel sizes/lengths in the radial direction versus the tangential direction. (e.g., the pixels of the sensor 108 have different sizes along two orthogonal directions). The use of non-square pixels may reduce SNR during scanning. In embodiments, the scanning acoustic microscope system 100 may include dual-sided sensors 108 (e.g., back and front) for improved sensitivity and throughput.

In embodiments, the scanning acoustic microscope system 100 scanning in X-Y mode is configured to scan pixels of the sample 110 that are non-square. For example, the sensor 108 of the scanning acoustic microscope system 100 may be configured to scan pixels with unequal pixel sizes/lengths between the X axis and Y axis. (e.g., the pixels of the sensor 108 have different sizes along two orthogonal directions).

In embodiments, the scanning acoustic microscope system 100 detects voids in the sample 110 in the presence of pattern of the device structures (e.g., printed circuitry) by minimizing the impact of the pattern noise during scanning. For example, the scanning acoustic microscope system 100 may utilize die-to-die or die-to-reference comparison methods to reject or minimize common or expected patterned backgrounds in the sample 110.

In embodiments, the sample is scanned independently by inspection or metrology means other than SAM, with results used to compare with scanning results by the scanning acoustic microscope system 100. For example, for a bonded wafer, an inspection tool or metrology tool may scan the two individual wafers before bonding. By using independently measured background patterns, the scanning acoustic microscope system 100 may improve pattern detection and classification sensitivity by selecting an appropriate algorithm and/or its parameters (e.g. thresholds). Inspection data and/or metrology data included in these independent measurements may include shape data, thickness data (e.g., layer thickness), nano topography data, mapping data (e.g., utilizing die layouts and/or database layouts), in-plane displacement (IPD) data. These data may assist in identifying areas likely to exhibit higher void density. The measurements may also include film thickness data and stress data.

In embodiments, the scanning acoustic microscope system 100 includes, or is integrated with, an inspection tool and/or metrology tool. For example, the scanning acoustic microscope system 100 may be integrated with a flatness/shape metrology tool. In another example, the scanning acoustic microscope system 100 may be integrated with a pattern defect inspection tool. In another example, the scanning acoustic microscope system 100 may be integrated with an edge inspection tool.

In embodiments, the scanning acoustic microscope system 100 combines multiple measurements from different scanning conditions. For example, the scanning acoustic microscope system 100 may take several scans of the sample 110 under different acoustic frequencies and/or transducer powers. In another example, the scanning acoustic microscope system 100 may take several scans of the sample 110 using different integration times. In another example, the scanning acoustic microscope system 100 may take several scans of the sample 110 using different sampling (e.g., pixel) sizes. The scans are then combined, increasing the sample detail that may be realized with a single scan. For example, combining multiple scans may increase the detail of, or allow greater focus on, penetration depth. Combining scans may also facilitate the determination of a wider variety of defects or feature types. Combining scans may also facilitate the ability of the scanning acoustic microscope system 100 to extend the dynamic range of measurement for defect and/or feature parameters.

In embodiments, the metrology recipe or inspection recipe is implemented by incorporating the data from the multiple scans. For example, program instructions stored in memory 118 may cause the one or more processors 116 to implement the metrology recipe by receiving additional data associated with the sample 110 (e.g., via the multiple scans), correlating the additional data with one or more measurements (e.g., of the original scan or scans), and adjusting the one or more measurements based on the additional data.

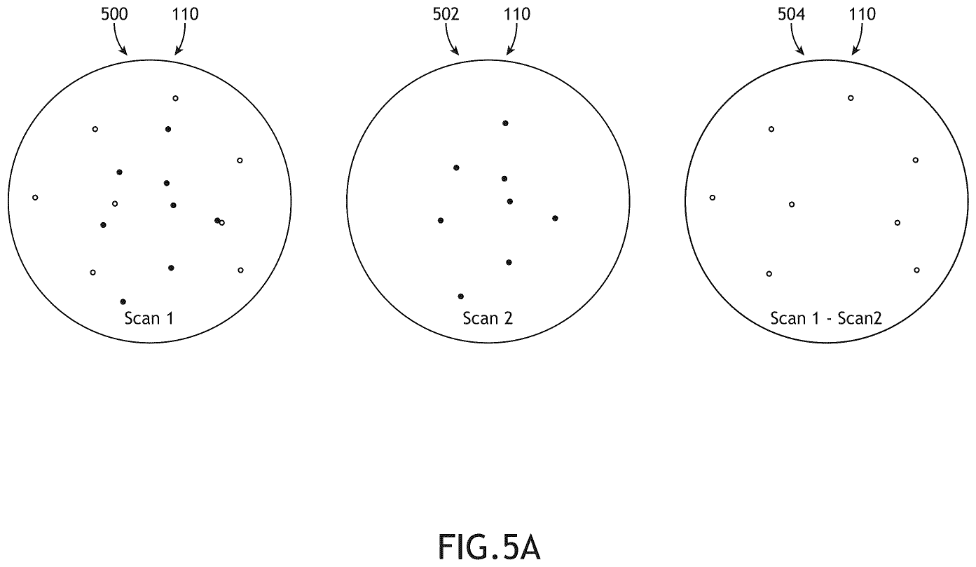

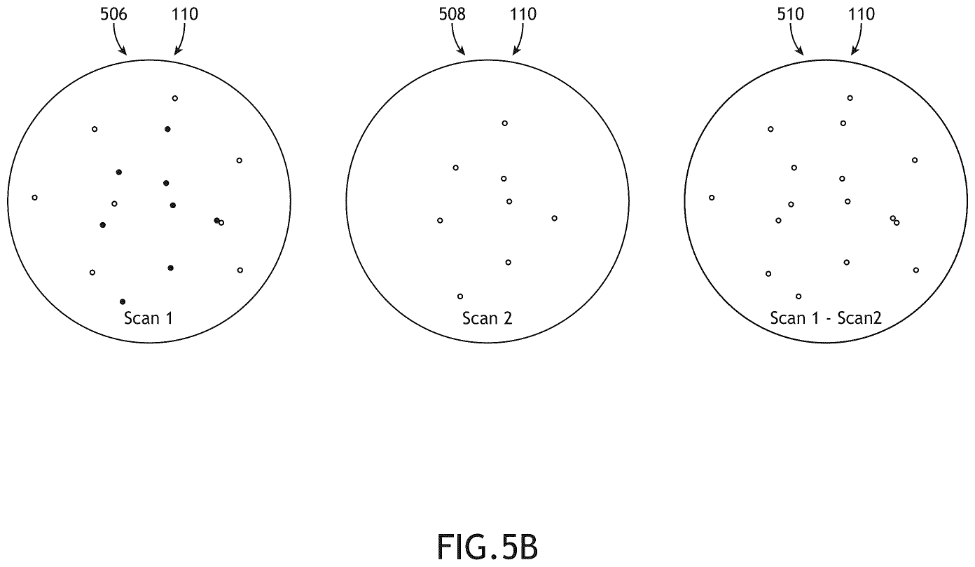

FIG. 5A illustrates test scans of a sample 110 scanned under different acoustic frequencies, in accordance with one or more embodiments of the disclosure.

In embodiments, the scanning acoustic microscope system 100 can be used to differentiate between different defects or features by combining scans and/or scan data using different scanning parameters. For example, by setting the acoustic frequency of the scanning acoustic microscope system 100 for deep defect detection, both deep defects and shallow defects may be identified, as shown in a first scan 500 of a sample 110. Deep defects are depicted as hollow circles, while shallow defects are depicted as filled circles The acoustic frequency of the scanning acoustic microscope system 100 may then be set for shallow defect detection, resulting in only the shallow defects being identified, as shown in a second scan 502 of the sample 110. By combining the first scan 500 and the second scan 502 (e.g., by removing defects that are present in both scans, which are the shallow defects), a third scan 504 may be produced that identifies only the deep defects.

FIG. 5B illustrates test scans of a sample 110 scanned under different transducer powers, in accordance with one or more embodiments of the disclosure. In embodiments, the scanning acoustic microscope system 100 can be used to extend sizing dynamic ranges by combining scans and/or scan data under varying transducer power or by using different channels with lower sensitivity. For example, a sample 110 may be scanned under a high transducer power which can effectively measure small defects due to an unsaturated signal, but saturates larger defects that cannot be effectively measured due to saturation, as shown in a first scan 506 of FIG. 5B. Large defects are depicted as hollow circles, while small defects are depicted as filled circles. Scanning at a lower transducer power (e.g., as shown in a second scan 508) does not saturate the larger defects, allowing them to be properly sized. However, scanning at the lower transducer power fails to identify the smaller defect. By combining the first scan 508 and the second scan 510, a third scan 510 may be produced that correctly identifies the sizes of both small defects and large defects. In this manner, as well as described elsewhere herein, the measurement assemblies 102 and/or stage 112 may be configured to provide multiple measurements of common locations of the sample 110 under different measurement conditions which enable the controller 114 to implement the metrology recipe by generating one or more combined measurements based on the different measurement conditions.

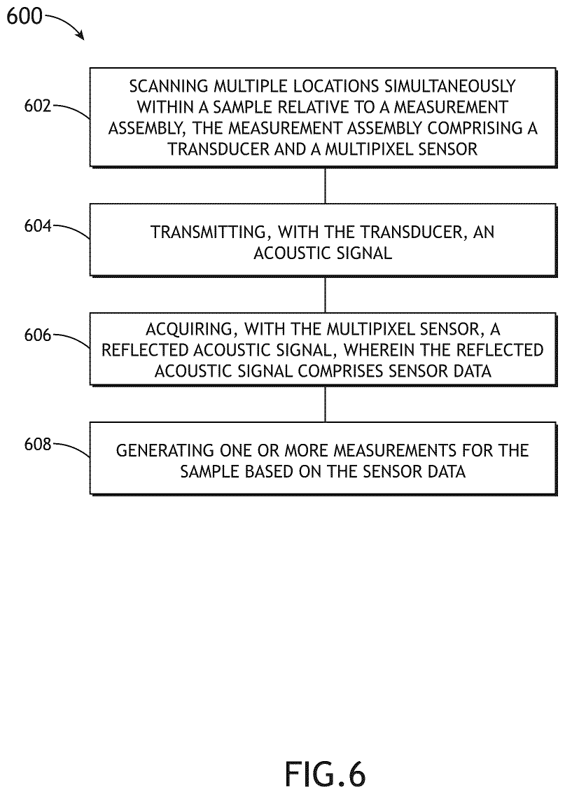

FIG. 6. Illustrates a process flow diagram depicting a method 600 for measuring a sample 110 via the scanning acoustic microscope system 100, in accordance with one or more embodiments of the disclosure. The method 600 generally describes using the scanning acoustic microscope system 100 to implement a metrology recipe. For example, the method 600 may be used to detect voids in a double-sided wafer.

In embodiments, the method includes a step 602 of scanning multiple locations simultaneously within a sample 110 relative to a measurement assembly 102, the measurement assembly 102 comprising a transducer 104 and a multipixel sensor 108. In embodiments, the method 600 includes a step 604 of transmitting, with the transducer 104, an acoustic signal. In embodiments, the method 600 includes a step 606 of acquiring, with the with the multipixel sensor 108, a reflected acoustic signal, wherein the reflected acoustic signal comprises sensor data. In embodiments, the method 600 includes a step 608 of generating one or more measurements for the sample 110 based on the sensor data. These measurements may include measurements generated from single wafers or measurements generated from multiple wafers (e.g., two, three, or more, wafers) that have been bonded together. For example, because the scanning acoustic microscope system 100 can detect defects deep within a substrate, measurements can be generated from both a top wafer and a bottom wafer of a bonded wafer set.

Referring to FIG. 1, the one or more processors 116 of a controller 114 may include any processor or processing element known in the art. For the purposes of the present disclosure, the term “processor” or “processing element” may be broadly defined to encompass any device having one or more processing or logic elements (e.g., one or more micro-processor devices, one or more application-specific integrated circuit (ASIC) devices, one or more field programmable gate arrays (FPGAs), or one or more digital signal processors (DSPs)). In this sense, the one or more processors 116 may include any device configured to execute algorithms and/or instructions (e.g., program instructions stored in memory). In embodiments, the one or more processors 116 may be embodied as a desktop computer, mainframe computer system, workstation, image computer, parallel processor, networked computer, or any other computer system configured to execute a program configured to operate or operate in conjunction with the scanning acoustic microscope system 100, as described throughout the present disclosure

Moreover, different subsystems of the scanning acoustic microscope system 100 may include a processor or logic elements suitable for carrying out at least a portion of the steps described in the present disclosure. Therefore, the above description should not be interpreted as a limitation on the embodiments of the present disclosure but merely as an illustration. Further, the steps described throughout the present disclosure may be carried out by a single controller 114 or, alternatively, multiple controllers. Additionally, the controller 114 may include one or more controllers housed in a common housing or within multiple housings. In this way, any controller or combination of controllers may be separately packaged as a module suitable for integration into the scanning acoustic microscope system 100

The memory medium 118 may include any storage medium known in the art suitable for storing program instructions executable by the associated one or more processors 132. For example, the memory medium 118 may include a non-transitory memory medium. By way of another example, the memory medium 118 may include, but is not limited to, a read-only memory (ROM), a random-access memory (RAM), a magnetic or optical memory device (e.g., disk), a magnetic tape, a solid-state drive and the like. It is further noted that memory medium 118 may be housed in a common controller housing with the one or more processors 116. In embodiments, the memory medium 118 may be located remotely with respect to the physical location of the one or more processors 116 and controller 114. For instance, the one or more processors 116 of controller 114 may access a remote memory (e.g., server), accessible through a network (e.g., internet, intranet and the like).

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable and/or wirelessly interacting components, and/or logically interacting and/or logically interactable components.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

What is claimed:

1. A scanning acoustic microscope system comprising:
one or more measurement assemblies, wherein a respective measurement assembly comprises a transducer and a receiver, wherein the receiver of the respective measurement assembly comprises a multipixel sensor to simultaneously generate sensor data for multiple locations associated with a sample;
a stage configured to scan the sample for measurement by the one or more measurement assemblies; and
a controller communicatively coupled to the one or more measurement assemblies, wherein the controller includes one or more processors configured to execute program instructions causing the one or more processors to implement a metrology recipe by:
receiving the sensor data from the one or more measurement assemblies while the sample is scanned by the stage; and
generating one or more measurements for the sample based on the sensor data.

2. The scanning acoustic microscope system of claim 1, wherein the one or more measurements comprise inspection measurements.

3. The scanning acoustic microscope system of claim 2, wherein the program instructions further cause the one or more processors to implement the metrology recipe by at least one of identifying or classifying defects on the sample based on the inspection measurements.

4. The scanning acoustic microscope system of claim 1, wherein the one or more measurements comprise metrology measurements.

5. The scanning acoustic microscope system of claim 1, wherein the multipixel sensor comprises:
a one-dimensional line sensor.

6. The scanning acoustic microscope system of claim 1, wherein the multipixel sensor comprises:
a time-delayed-integration (TDI) sensor.

7. The scanning acoustic microscope system of claim 1, wherein the multipixel sensor comprises:
a two-dimensional array sensor.

8. The scanning acoustic microscope system of claim 1, wherein the multipixel sensor comprises:
a dual-sided sensor.

9. The scanning acoustic microscope system of claim 1, wherein a channel direction is aligned along a radial axis of the sample, wherein pixels of the multipixel sensor scanning along the channel comprise a radial length and a tangential length, wherein the radial length and the tangential length differ.

10. The scanning acoustic microscope system of claim 7, wherein the two-dimensional array sensor operates in a step-and-scan mode.

11. The scanning acoustic microscope system of claim 1, wherein the one or more measurement assemblies comprise two or more measurement assemblies distributed along a channel direction.

12. The scanning acoustic microscope system of claim 11, wherein the stage translates the sample in a scan direction orthogonal to the channel direction during the measurement.

13. The scanning acoustic microscope system of claim 11, wherein the channel direction is aligned along a radial axis of the sample, wherein the stage rotates the sample during the measurement.

14. The scanning acoustic microscope system of claim 13, wherein the stage positions an outer radial edge of the sample under the one or more measurement assemblies for the measurement.

15. The scanning acoustic microscope system of claim 11, wherein sizes of measurement fields along the channel direction of the two or more measurement assemblies are separated by gaps, wherein the stage is configured to translate the sample along two or more measurement swaths, wherein a first measurement swath of the two or more measurement swaths is at least partially interleaved with a second measurement swath of the two or more measurement swaths to provide that the measurement fields of the first measurement swath at least partially fill at least some of the gaps of the second measurement swath.

16. The scanning acoustic microscope system of claim 1, wherein at least one of the one or more measurement assemblies or the stage are configured to provide different measurement conditions for two or more measurement zones on the sample.

17. The scanning acoustic microscope system of claim 16, wherein at least one of the one two or more measurement zones corresponds to an outer radial edge region of the sample.

18. The scanning acoustic microscope system of claim 16, wherein the different measurement conditions comprises different scan speeds in the different measurement zones.

19. The scanning acoustic microscope system of claim 1, wherein the program instructions further cause the one or more processors to implement the metrology recipe by:
receiving additional data associated with the sample;
correlating the additional data with the one or more measurements; and
adjusting the one or more measurements based on the additional data.

20. The scanning acoustic microscope system of claim 19, wherein the one or more measurements comprise one or more inspection measurements, wherein the additional data comprises additional metrology data.

21. The scanning acoustic microscope system of claim 20, wherein adjusting the one or more measurements based on the additional data comprises adjusting one or more inspection algorithms based on the additional metrology data.

22. The scanning acoustic microscope system of claim 20, wherein the additional metrology data comprises:
at least one of layer thickness, feature shape, or nano topography data.

23. The scanning acoustic microscope system of claim 1, wherein at least one of the one or more measurement assemblies or the stage are configured to provide multiple measurements of common locations of the sample under different measurement conditions, wherein the program instructions are further configured to cause the one or more processors to implement the metrology recipe by generating one or more combined measurements based on the different measurement conditions.

24. A system comprising:
a controller communicatively coupled to one or more measurement assemblies and a stage, wherein a respective one of the one or more measurement assemblies comprises a transducer and a receiver, wherein the receiver of at least one of the one or more measurement assemblies comprises a multipixel sensor to simultaneously generate sensor data for multiple locations associated with a sample, wherein the stage is configured to scan the sample for measurement by the one or more measurement assemblies, wherein the controller includes one or more processors configured to execute program instructions causing the one or more processors to implement a metrology recipe by:
receiving the sensor data from the one or more measurement assemblies while the sample is scanned by the stage; and
generating one or more measurements for the sample based on the sensor data.

25. A method, comprising:
scanning multiple locations simultaneously within a sample relative to a measurement assembly, the measurement assembly comprising a transducer and a multipixel sensor;
transmitting, with the transducer, an acoustic signal;
acquiring, with the multipixel sensor, a reflected acoustic signal, wherein the reflected acoustic signal comprises sensor data; and
generating one or more measurements for the sample based on the sensor data.
